(19) United States
(12) Patent Application Publication
(10) Pub. No.: US 2021/0406855 A1
(43) Pub. Date: Dec. 30, 2021

(54) SYSTEMS AND METHODS FOR PROVIDING A TONE-BASED KIOSK SERVICE

(71) Applicant: Nicholas-Alexander LLC, Las Vegas, NV (US)

(72) Inventor: Thomas Webster, Las Vegas, NV (US)

(21) Appl. No.: 17/360,410

(22) Filed: Jun. 28, 2021

Related U.S. Application Data
(60) Provisional application No. 63/045,459, filed on Jun. 29, 2020.

(51) Int. Cl. G06Q 20/18; G06Q 20/32; G06Q 20/20; G06Q 50/14; G06Q 10/02; G06Q 30/06; H04W 12/033; G01C 21/20

(52) U.S. Cl. CPC G06Q 20/18; G06Q 20/3272; G06Q 20/322; G06Q 20/202; G01C 21/206; G06Q 50/14; G06Q 10/02; G06Q 30/0613; H04W 12/033; G06Q 20/204

(57) ABSTRACT

Embodiments provided herein include systems and methods for providing a tone-based kiosk service. One embodiment of a tone-based kiosk includes a display, a processor, and a memory component. The memory component may be configured to store logic that, when executed by the processor, causes the tone-based kiosk to establish an encrypted connection with the mobile device and broadcast a first tone that includes first encrypted data for rendering a user interface at the mobile device, wherein the first encrypted data includes information related to offerings by the establishment. In some embodiments, the logic causes the tone-based kiosk to provide at least a portion of the user interface for display, receive a second tone that includes second encrypted data that includes instructions navigating the user interface via the mobile phone to create order details for an order, and receive an indication that the order is complete.

### CROSS REFERENCE

This application claims the benefit U.S. Provisional Application Ser. No. 63/045,459, entitled Systems and Methods for Providing a Tone-Based Kiosk Services, filed on Jun. 29, 2020, which is hereby incorporated by reference in its entirety.

### TECHNICAL FIELD

Embodiments described herein generally relate to systems and methods for providing a tone-based kiosk service and, more specifically, to embodiments for providing a tone-based kiosk service for restaurant, airline, and/or other similar applications.

### BACKGROUND

Currently, many kiosk-based services are provided by retail-based establishments to increase efficiency and allow the patron to receive services without interacting with employees directly. As an example, many airlines now provide kiosk check-in, which allows patrons to indicate the number of bags they are bringing, attest to the regulatory jargon, pay for additional services, and/or provide other options. While these kiosks have added convenience, patrons are required to interact physically with a community device that can spread germs among patrons.

Additionally, many retail establishments provide a mobile application to provide services. In the airline example, a patron may log into the patron's user account to check into a flight and/or receive other information and services. While the mobile application may provide some services without having to interact physically with a community device, there are situations where the establishment and/or the patron may desire that the patron be physically present. There are also situations where current infrastructure is better situated for utilization of a kiosk. As such, a need exists in the industry for providing tone-based kiosk services.

### SUMMARY

Embodiments provided herein include systems and methods for providing a tone-based kiosk service. One embodiment of a tone-based kiosk includes a display, a processor, and a memory component. The memory component may be configured to store logic that, when executed by the processor, causes the tone-based kiosk to establish an encrypted connection with the mobile device and broadcast a first tone that includes first encrypted data for rendering a user interface at the mobile device, where the first encrypted data includes information related to offerings by the establishment. In some embodiments, the logic causes the tone-based kiosk to provide at least a portion of the user interface for display, receive a second tone that includes second encrypted data that includes instructions navigating the user interface via the mobile device to create order details for an order, and receive an indication that the order is complete.

One embodiment of a method includes broadcasting, by a tone-based kiosk, a first tone that is imperceptible by a human. The first tone includes a first identifier of the tone-based kiosk, and where the tone-based kiosk serves an establishment. The method may also include receiving, by the tone-based kiosk, a second tone from a mobile device of a patron, where the second tone includes a second identifier of the mobile device. Some embodiments of the method include displaying, by the tone-based kiosk, an image that includes an encryption key for capture by the mobile device, where the encryption key is used by the mobile device and the tone-based kiosk to establish an encrypted connection. Similarly, some embodiments include broadcasting, by the tone-based kiosk, a third tone that includes first encrypted data for rendering a user interface at the mobile device, where the first encrypted data includes information related to offerings by the establishment, and where the first encrypted data is received by the mobile device, decrypted, and displayed as the user interface. Some embodiments include displaying, by the tone-based kiosk, at least a portion of the user interface, receiving, by the tone-based kiosk, a fourth tone that includes second encrypted data that includes instructions navigating the user interface via the mobile device to create order details for an order, and communicating, by the tone-based kiosk, at least a portion of the order details to an establishment device for processing the order. Some embodiments include receiving, by the tone-based kiosk, an indication that the order is complete and broadcasting, by the tone-based kiosk, a fifth tone that includes third encrypted data indicating that the order is complete.

One embodiment of a system includes a tone-based kiosk with a display coupled to a processor and a memory component, where the memory component stores logic that, when executed by the processor, causes the tone-based kiosk to broadcast a first tone that is imperceptible by a human, where the first tone includes a first identifier of the tone-based kiosk and where the tone-based kiosk serves an establishment. Some embodiments cause the system to receive a second tone from a mobile device of a patron, where the second tone includes a second identifier of the mobile device and establish an encrypted connection with the mobile device. In some embodiments, the logic causes the system to broadcast a third tone that includes first encrypted data for rendering a user interface at the mobile device, where the first encrypted data includes information related to offerings by the establishment and where the first encrypted data is received by the mobile device, decrypted, and displayed as the user interface. In some embodiments, the logic causes the system to provide at least a portion of the user interface for display, receive a fourth tone that includes second encrypted data that includes instructions navigating the user interface via the mobile device to create order details for an order, and receive an indication that the order is complete. In some embodiments, the logic causes the system to broadcast a fifth tone that includes third encrypted data indicating that the order is complete.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts a computing environment for providing a tone-based kiosk service, according to embodiments described herein;

FIG. 2 depicts an establishment for providing tone-based kiosk services, according to embodiments described herein;

FIG. 3 depicts a user interface for welcoming a patron of a restaurant, according to embodiments described herein;

FIG. 4 depicts a user interface for a patron to place an order with a restaurant, according to embodiments described herein;

FIG. 5 depicts a user interface for a patron to complete an order with a restaurant, according to embodiments described herein;

FIG. 6 depicts a user interface for providing an expected time until an order is ready, according to embodiments described herein;

FIG. 7 depicts a kiosk interface for providing a menu to a patron of a restaurant, according to embodiments described herein;

FIG. 8 depicts a kiosk interface for providing ordering information to a patron of a restaurant, according to embodiments described herein;

FIG. 9 depicts a user interface for welcoming a patron of an airline, according to embodiments described herein;

FIG. 10 depicts a user interface for providing options to a patron of an airline, according to embodiments described herein;

FIG. 11 depicts a kiosk interface for providing airline options to a patron of an airline, according to embodiments described herein;

FIG. 12 depicts a flowchart for providing tone-based kiosk services by integrating with a user account, according to embodiments described herein;

FIG. 13 depicts a flowchart for providing tone-based kiosk services, according to embodiments described herein;

FIG. 14 depicts a flowchart for providing tone-based kiosk services to a restaurant patron, according to embodiments described herein;

FIG. 15 depicts a flowchart for providing tone-based kiosk services to an airline patron, according to embodiments described herein; and

FIG. 16 depicts components of a tone-based kiosk, according to embodiments described herein.

### DETAILED DESCRIPTION

Embodiments disclosed herein include systems and methods for providing a tone-based kiosk service. Some embodiments may be configured such that a restaurant, an airline, retail establishment, and/or other service establishment has one or more tone-based kiosks devices on premises. The tone-based kiosk may be configured to provide one or more user interfaces associated with the services that that establishment provides. Additionally, the tone-based kiosk may be configured to send and/or receive non-naturally occurring audio tones (or tone pairs) that are imperceptible by a human due to frequency, volume, noise, and/or for other reasons. As a patron approaches the tone-based kiosk or otherwise engages the kiosk, the patron's mobile device may be configured to receive the tones, decipher the data embedded in the tones, and create its own tone-based messages that may be received and deciphered by the tone-based kiosk.

In some embodiments, the patron may approach a tone-based kiosk and, due to proximity to the tone-based kiosk or other reason discussed herein, the patron's mobile device may recognize which tone-based kiosk the patron is using and the tone-based kiosk may recognize which mobile device and/or user account is accessing the tone-based kiosk. In some embodiments, the patron may approach the tone-based kiosk, log into a mobile application of the establishment and, due to proximity, a selection of a user option, and/or via other mechanism, the tone-based kiosk may be paired with the mobile device and tone-based communications (in some embodiments via an encrypted connection). Once the tone-based kiosk and the mobile device are paired, the mobile device may receive and mirror user interfaces provided by the tone-based kiosk. In some embodiments, the user interfaces may be provided by the tone-based kiosk and the tone-based kiosk may communicate data associated with user input to the mobile device. As an example, the tone-based kiosk may provide a different user interface that only includes the options and/or fields requested by the user interface being provided by the tone-based kiosk. As such, the patron uses the mobile device simply as an input device for the tone-based kiosk. As the patron submits the data via a tone-based communication, the tone-based kiosk may or may not display the input data prior to submitting.

The example above discusses embodiments where the patron logs into his/her account on the mobile application via the mobile device. These embodiments may be utilized for authenticating the user and establishing an encrypted connection. Specifically, once the patron has logged into his/her account, the tone-based kiosk may provide a secondary authentication to ensure that the tone-based kiosk is communicating with the correct mobile device. Such a secondary authentication could take the form of known dual layer authentication mechanisms and/or could include the tone-based kiosk displaying a picture (static and/or video), providing audio, and/or providing other output that the mobile device captures and sends back via the tone-based protocol. If the mobile device communicates the appropriate data, an encrypted tunnel may be created between the tone-based kiosk and the mobile device.

As an example, existing menu boards and ordering kiosks may be outfitted with tone-communicating capabilities. A patron may approach and a mobile application on the mobile device may interact with a unique tone tag that aligns the patron to a tone-based kiosk. The patron may use the mobile application as the only user interface for the order. The patron may use a standard mobile application login credentials and/or other mechanism for authenticating. The mobile application may initiate the ordering process on the mobile device, executing any desired adjustments to the standard menu items selected. While the order is delivered to the preparation station and payment is being finalized, the tone-based kiosk may display a custom message and/or information specific to the patron (rewards, point balances, etc.).

In some embodiments, data is exchanged and transaction inputs are captured in a cloud-based infrastructure. Once completed, the patron may be prompted on the mobile device to accept an electronic receipt. The tone-based communications may align the patron to a specific menu board and ordering mechanism, so any printed receipt and/or ordered time are directed to the correct location. In some embodiments, the data is electronically finalized and the patron is prompted on both the mobile application and the kiosk screen to take a table marker and collect any receipts. Because the patron is using the mobile application during the touchless process, additional tone-based functionality (e.g., in application message, offers, coupons, contest entries, loyalty rewards, etc.) are readily available.

In some embodiments, existing check-in kiosks may be outfitted with tone-based hardware and/or software to be utilized as a tone-based kiosk. As a traveler approaches a tone-based kiosk for an airline, the mobile device may interact with a unique tone-tag associated with that particular tone-based kiosk, aligning the patron to the specific tone-based kiosk. The patron may utilize a mobile application hosted by the airline via the mobile device as the only user interface for the tone-based kiosk. The patron may use standard login credentials and/or may login and/or register via the normal process provided at a standard kiosk. In some embodiments, the mobile application my initiate the check-in process on the mobile device, executing steps to compete check-in and checking of luggage. While the patron is proceeding through the check-in process, the tone-based kiosk may display a custom message and/or information specific to the patron (e.g., flight information, gate information, frequent flier balance, etc.).

In some embodiments, data may be exchanged and the patron inputs may be captured. Once completed, the patron may be prompted on the mobile device to accept an electronic boarding document. Any baggage tags may be printed. Printing of physical boarding passes is available as an option. These embodiments have aligned the patron's mobile device to the specific tone-based kiosk so that the document prints to the desired location. In some embodiments, the data may be electronically finalized and the patron may be prompted on the mobile application and/or the tone-based kiosk to take an affix the printed luggage tag, collect any other documents, the specific bag-drop number, gate number, etc. Because the traveler is using the mobile application, additional tone-based functionality (e.g., in-gate messaging, in-flight engagement, personalized flight attendant interaction, etc.) is readily available. The systems and methods for providing a tone-based service incorporating the same will be described in more detail, below.

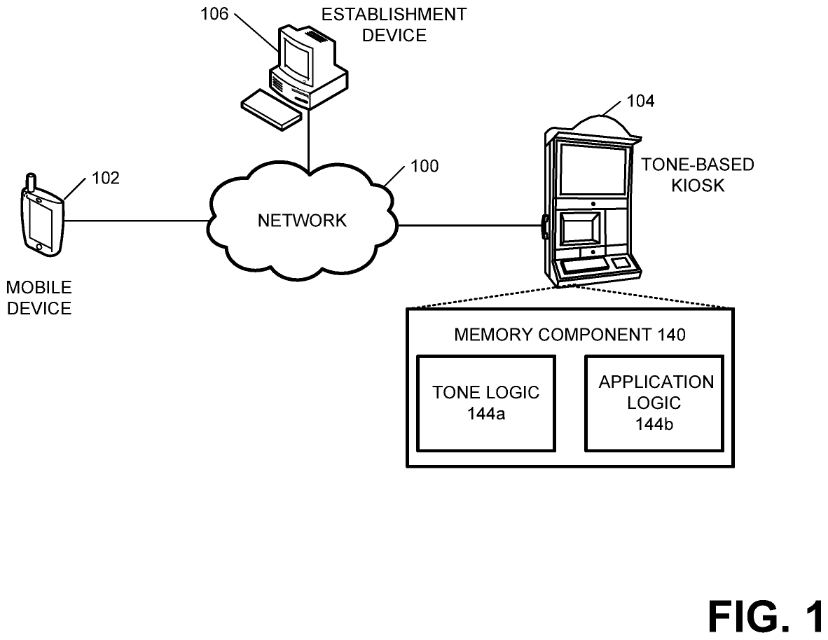

Referring now to the drawings, FIG. 1 depicts a computing environment for providing a tone-based kiosk 104 service, according to embodiments described herein. As illustrated, the computing environment may include a network 100, which may include a wide area network (wired or wireless), such as the internet, a cellular network, or other communications network for communicating devices across a wide area. Similarly, the network 100 may include a wired or wireless local area network for communicating data, including tone-based and/or other peer-to-peer network communications, as described herein.

Coupled to the network 100 are a mobile device 102, a tone-based kiosk 104, and an establishment device 106. The mobile device 102 may be configured as a mobile phone, tablet, personal computer, and/or other computing device that might be within a tone-based communication range of the tone-based kiosk 104. Additionally, the mobile device 102 may be configured for tone-based communications when the patron has arrived at the tone-based kiosk 104, and thus may include a speaker, a microphone, as well as other hardware and software for generating, receiving, and interpreting the non-naturally occurring inaudible tones described herein.

Also included is the tone-based kiosk 104. The tone-based kiosk 104 may represent one or more devices positioned in proximity to the establishment for communicating tone-based data with the mobile device 102 and/or establishment device 106. Depending on the particular embodiment, the tone-based kiosk 104 may be include a computing device, display, an input device (which may or may not be part of the display as a touch screen), a speaker, and/or a microphone. Regardless, the tone-based kiosk 104 may be configured for communicating with both the mobile device 102 and the establishment device 106, as described in more detail below. The tone-based kiosk 104 may thus include a memory component 140, which may store tone logic 144a and application logic 144b. As discussed in more detail below, the tone logic 144a may cause the tone-based kiosk 104 to decipher a received tone, construct tone-based messages, receive new data for creating a new tone, and/or perform other functionality related to the communication of tones. The application logic 144b may be configured for causing the tone-based kiosk 104 to execute an application that provides the services for which the patron is visiting the tone-based kiosk 104 (e.g., ordering functionality, check-in functionality, providing menu data, providing scheduling, etc.).

The establishment device 106 may be configured as and/or include a personal computer, tablet, mobile device, and/or other device for providing administrative functions for the tone-based kiosk 104. As an example, a user of the establishment device 106 may be configured as a personal computer, tablet, mobile phone, and/or other device for creating messages for communication via the tone-based kiosk 104, receiving payments, providing advertisements, and/or providing other functionality for the establishment. In some embodiments, the establishment device 106 is distinct from the tone-based kiosk 104; however, some embodiments are configured such that at least a portion of the components and/or functionality of the establishment device 106 and the tone-based kiosk 104 are combined.

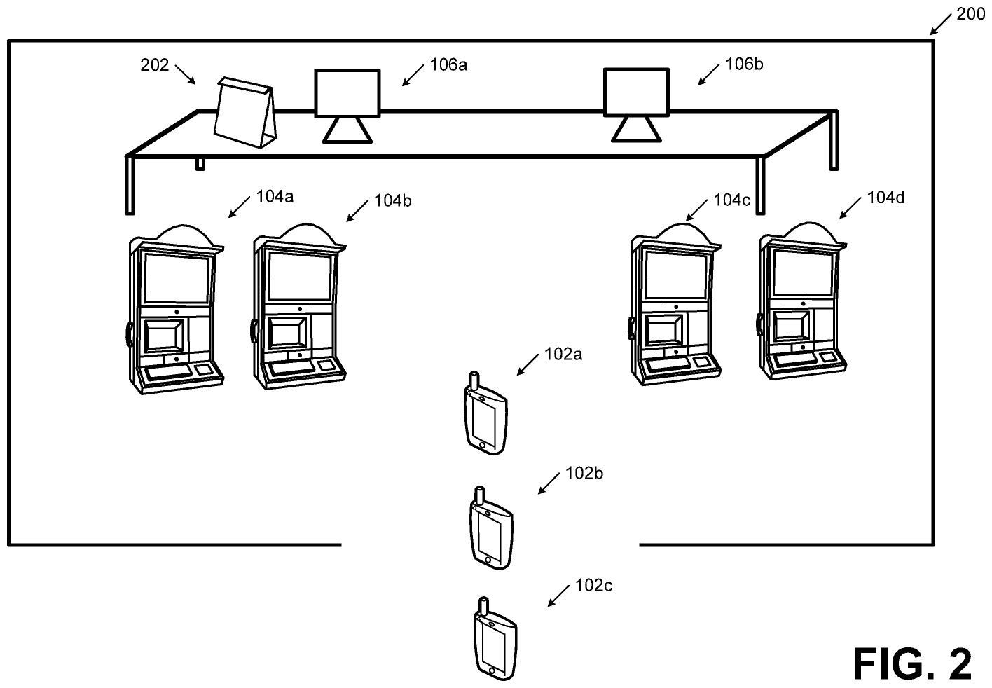

FIG. 2 depicts an establishment 200 for providing tone-based kiosk services, according to embodiments described herein. As illustrated, the establishment 200 includes mobile devices 102a, 102b, 102c (collectively or individually “mobile device 102”) of patrons that enter the establishment 200. As described above, the establishment 200 may include any restaurant, airline, retail shop, or other establishment where a patron engages with the establishment 200.

Also included in the establishment 200 are one or more tone-based kiosks 104a, 104b, 104c, 104d (collectively or individually “tone-based kiosk 104”). The establishment 200 may also include one or more establishment devices 106a, 106b (collectively or individually “establishment device 106”). As discussed above, the tone-based kiosk 104 may be configured as merely a monitor and/or computing device, and/or may otherwise be configured to receive payment (e.g., include a cash collector, a card scanner, etc.), and/or may be configured to dispense one or more goods (e.g., drinks, food, products, etc.). Regardless, the tone-based kiosk 104 includes at least one microphone and/or speaker for communicating tones as described herein. The tone-based kiosk 104 may also include and/or be coupled to computing power capable of determining and decrypting tones received.

The establishment device 106 may be configured to receive orders from the tone-based kiosk 104 and facilitate orders. In some embodiments, based on the orders received, the establishment device 106 may determine a wait time for a particular order. Order data may be communicated among tone-based kiosks 104 and wait times may be communicated by a particular tone-based kiosk 104.

Accordingly, when a patron enters the establishment 200 with the mobile device 102, the mobile device 102 may receive a tone from one or more of the tone-based kiosks 104. Depending on the status of the tone-based kiosks 104, one or more of the tones may be encrypted such that mobile device 102a cannot interpret the data (meaning that the kiosk is currently being used). Similarly, one or more of the tones may be unencrypted, but provides information that is not relevant to this particular patron. One or more of the tones may include data that indicates that the tone-based kiosk 104a is available. This data may also include a message to the patron identifying itself, directions to reach the tone-based kiosk 104a, and/or other information.

It should be noted that some embodiments might utilize a plurality of the tone-based kiosks 104 to determine a location of the mobile devices 102. As such, the tone-based kiosks 104 may collectively determine that a patron with the mobile device 102b is closest to tone-based kiosk 104c, such that the tone-based kiosk 104c will broadcast a message directed to the mobile device 102c.

Once the patron reaches the desired tone-based kiosk 104, an invitation for an encrypted session may be established. One example may include the tone-based kiosk 104 displaying an image. The patron may capture the image with the mobile device 102, which is then sent back to the tone-based kiosk 104. The tone-based kiosk 104 may analyze the substance of the image received, as well as calculate a distance the mobile device 102 was from the tone-based kiosk 104 to determine whether the mobile device 102 is authenticated. Based on this distance, the tone-based kiosk 104 may output a tone with an encryption key that has a volume, frequency, and/or other characteristic that only that mobile device 102 can receive. Once the encryption key is established, the mobile device 102 and the tone-based kiosk 104 may commence an encrypted connection. In some embodiments, the image itself may provide the encryption key, such that when the mobile device 102 captures the image, the key is deciphered by the mobile device 102. If/when the mobile device 102 sends the image back to the kiosk for authentication, the encrypted tunnel may already be established.

Similarly, some embodiments may use the internet or other mechanism to establish the encryption key. As an example, a mobile application may provide authentication via a web server, which may be accessed by the patron using the mobile device 102. The web server may also communicate the encryption key to the tone-based kiosk 104 to establish the encrypted tunnel.

Once the encrypted connection is established, the tone-based kiosk 104 may display public information, such as menu, item description, prices, etc., but may communicate non-public information (such as patron name, order, payment type, etc.) to the mobile device 102. In some embodiments, the interfaces may be similar, but the tone-based kiosk 104 may be configured for redacting sensitive information, which is not redacted on the mobile device 102. In some embodiments, the user interfaces may be altogether different. Additionally, the patron may utilize the mobile device 102 to navigate the interfaces provided by the tone-based kiosk 104 and/or otherwise control the tone-based kiosk 104.

Once the order has been placed using the mobile device 102 and the tone-based kiosk 104, the order may be sent to the establishment device 106 for processing. The establishment device 106 may collect at least a portion of the orders from the tone-based kiosks 104 in an order queue and may communicate to the respective tone-based kiosk 104 when an order is ready. The tone-based kiosk 104 may communicate to the respective mobile device 102 when the order is ready.

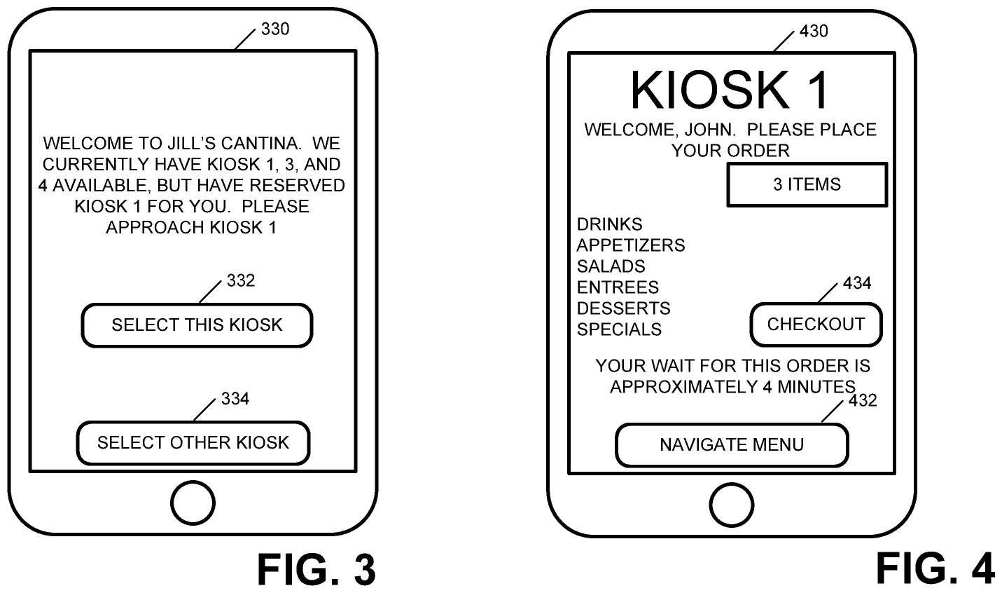

FIG. 3 depicts a user interface 330 for welcoming a patron of a restaurant, according to embodiments described herein. As illustrated, when the mobile device 102 is in proximity of a tone-based kiosk 104, the mobile device 102 may receive a tone broadcast by the tone-based kiosk 104. The tone may include data, including data for rendering the user interface 330. One or more of the tone-based kiosks 104 may determine a location of the mobile device 102 (via for example, triangulation using three tone-based kiosks or using two tone-based kiosks, if a third dimension location of the mobile device 102 is known) and may determine which tone-based kiosk 104 is desired for this patron. In response to selection of a select this kiosk option 332, the patron confirms that he/she will utilize the selected tone-based kiosk 104. In response to selection of a select other kiosk option 334, the patron may be provided with an option to connect with another tone-based kiosk 104. Once the desired tone-based kiosk 104 is confirmed by the patron, an encrypted tunnel may be established, as described above.

FIG. 4 depicts a user interface 430 for a patron to place an order with a restaurant, according to embodiments described herein. As illustrated, the user interface 430 may provide a customized welcome screen. Once the encrypted tunnel is established, the mobile device 102 may communicate account information to the tone-based kiosk 104, which may be utilized for acquiring and displaying name, address, past orders, account history, favorite purchases, payment mechanisms, etc.

Also provided in the user interface 430 is a menu. As described in more detail below, the menu may also be provided on the tone-based kiosk 104 to which the user is linked. As such, the user may navigate the user interface 430 via the mobile device 102 and/or the user may use the mobile device 102 to navigate the respective kiosk interface provided by the tone-based kiosk 104 via a navigate menu option. Once the order is complete, the patron may check out by selecting a checkout option 434.

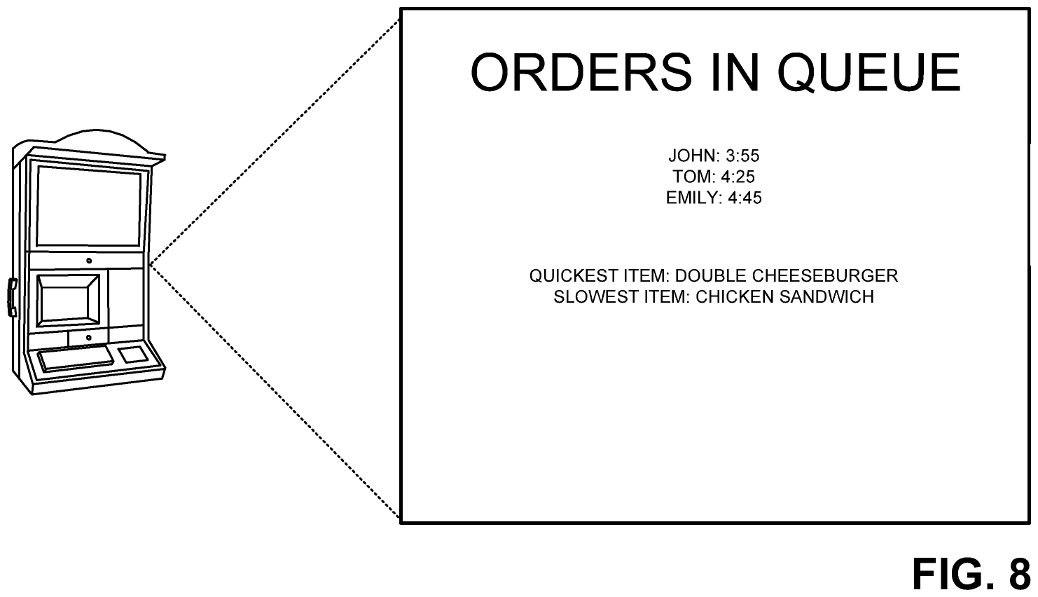

Also provided in the user interface 430 is a navigate option 432. In response to selection of the navigate option 432, the mobile device 102 may open another interface which allows the patron to navigate an associated kiosk interface, such as kiosk interface 830 (FIG. 8).

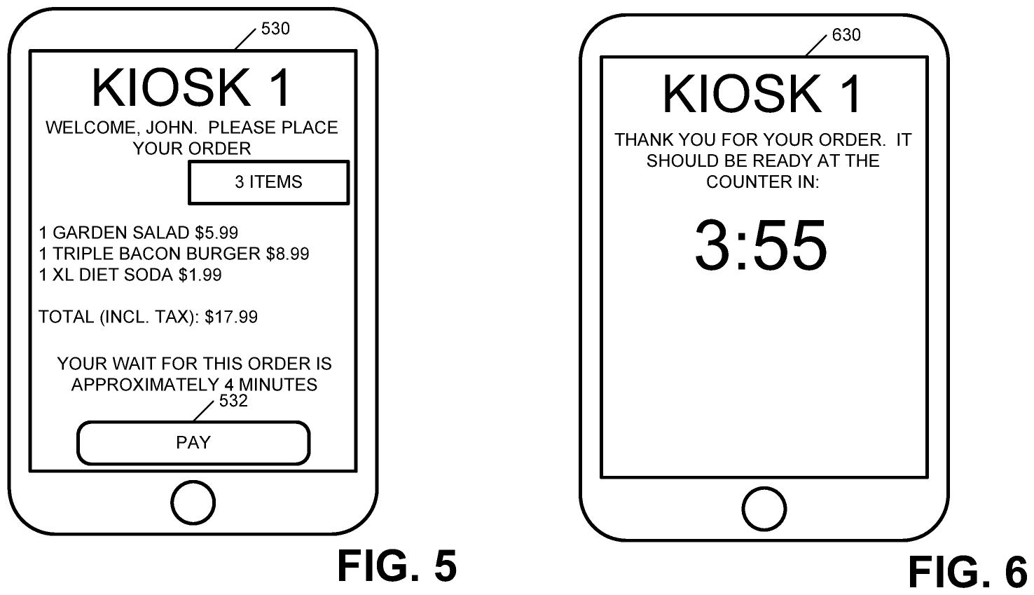

FIG. 5 depicts a user interface 530 for a patron to complete an order with a restaurant, according to embodiments described herein. As illustrated, the user interface 530 may provide a “cart” that depicts the items being ordered. A wait time may be calculated by the tone-based kiosk 104 and/or via an establishment device 106. The wait time can be used to allow the patron to change an order if the order will take too long to complete. Regardless, the wait time may be provided to the patron via the user interface 530. A pay option 532 may be selected for submitting payment. Payment may be facilitated via cash to the tone-based kiosk 104 or establishment employee; via card to the tone-based kiosk 104 or establishment employee; via the mobile device 102 using a tone-based communication; and/or via a stored payment mechanism at the tone-based kiosk 104 or establishment device 106.

FIG. 6 depicts a user interface 630 for providing an expected time until an order is ready, according to embodiments described herein. Once the order is placed, the tone-based kiosk 104 may determine a time that the order will be complete, based on other orders received, preparation time, etc., which may be communicated to the mobile device 102 and displayed as the user interface 630.

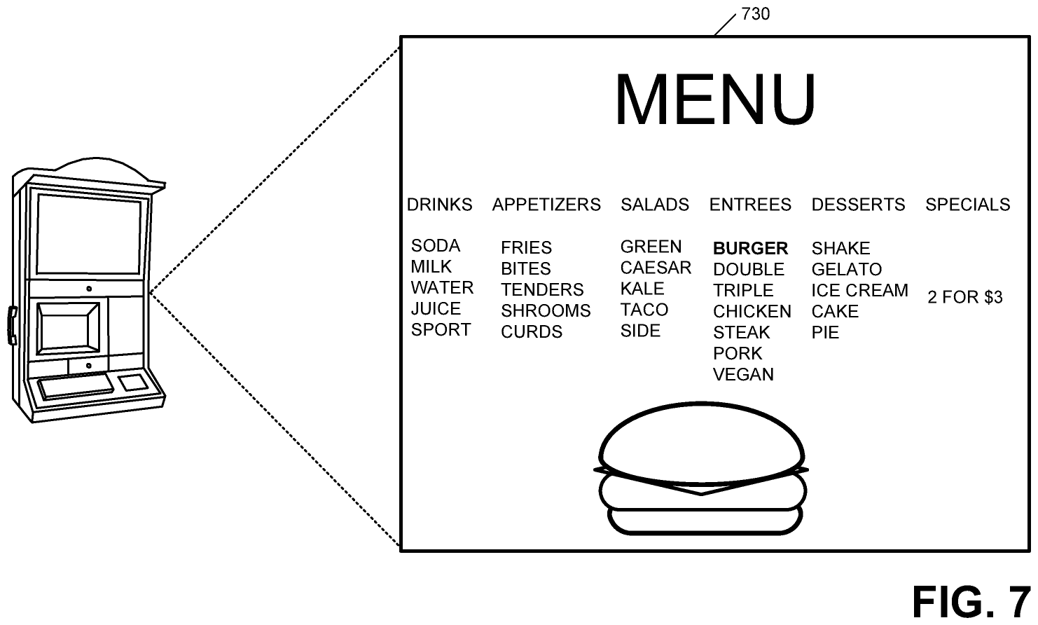

FIG. 7 depicts a kiosk interface 730 for providing a menu to a patron of a restaurant, according to embodiments described herein. As described above with regard to the user interface 430 of FIG. 4, the kiosk interface 730 may provide information that is not easily viewed on the mobile device 102, is non-sensitive data, and/or otherwise is desired to be viewed at the tone-based kiosk 104. Specifically, the kiosk interface 730 may provide images and/or other data of selected menu items. As described above, the patron may communicate commands to the tone-based kiosk 104 via tones provided by the mobile device 102.

FIG. 8 depicts a kiosk interface 830 for providing ordering information to a patron of a restaurant, according to embodiments described herein. As illustrated, the kiosk interface 830 provides a listing of orders in queue and the time expected for each to be complete. A prediction of the quickest items and the slowest items may also be made by the tone-based kiosk 104 and/or establishment device 106. A time for order completion of that item may also be provided. Specifically, the double cheeseburgers may be premade and may be very quick to complete. Chicken, on the other hand, may be frozen and take more time to complete. Similarly, French fries are often cooked in bulk. Based on the timing of the order, the time to complete the order may change. Thus, if a patron is in a rush, he/she may view the quickest and slowest orders to direct his/her order. Other embodiments may provide a preparation time for each menu item and/or rank the plurality of establishment offerings accordingly.

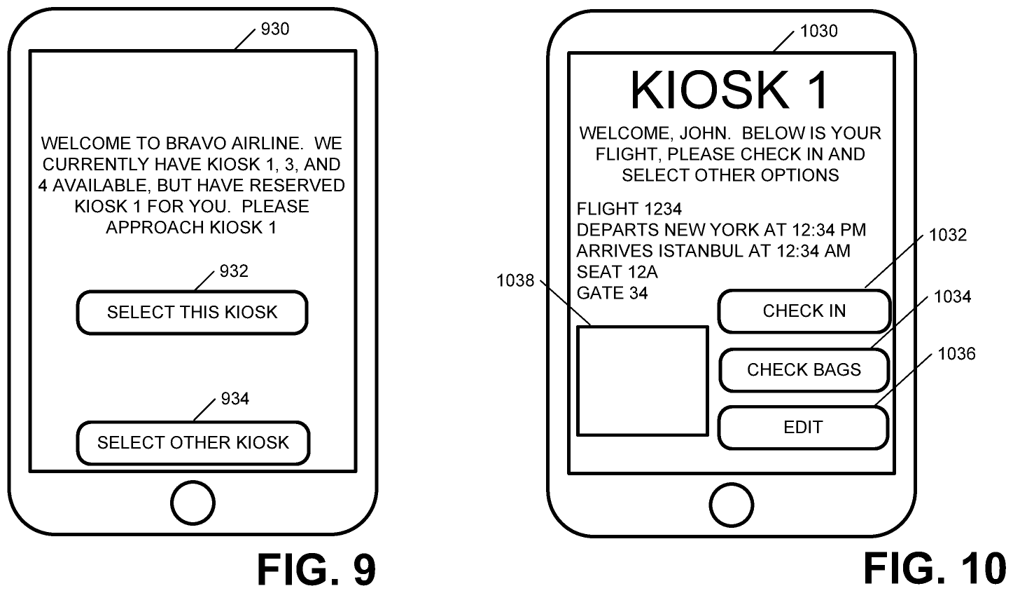

FIG. 9 depicts a user interface 930 for welcoming a patron of an airline, according to embodiments described herein. While the interfaces from FIGS. 3-8 refer generally to a restaurant, the interfaces for FIGS. 9-11 refer to an airline kiosk. As such, the user interface 930 is similar to the user interface 330 from FIG. 3 and provides a select this kiosk option 932 to select the recommended tone-based kiosk 104 and a select other kiosk option 934 to select another tone-based kiosk 104.

FIG. 10 depicts a user interface 1030 for providing options to a patron of an airline, according to embodiments described herein. As illustrated, the user interface 1030 provides flight information for the patron. Specifically, upon authenticating and encrypting, the mobile device 102 may provide identifying information to the tone-based kiosk 104 and the tone-based kiosk 104 (and/or establishment device 106) may look up and/or otherwise determine flight information, gate information, seat information, etc. and provided that information to the mobile device 102. The user interface 1030 may also include a check in option 1032 for the patron to check into a flight; a check bags option 1034 for the patron to check bags; and an edit option 1036 for the patron to change flights, and/or other information. In response to selecting the check bags option 1034, the patron may be prompted for payment. As described above, payment may be made via a tone-based communication of the payment information and/or via other mechanisms.

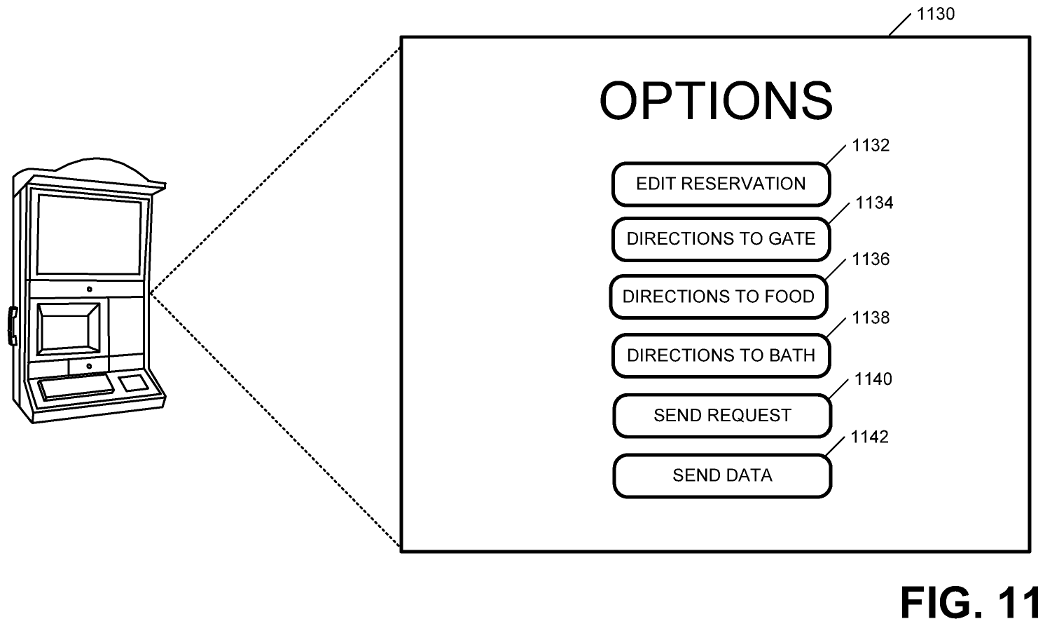

Also provided in the user interface 1030 is a navigate screen 1038 for navigating a kiosk interface (such as kiosk interface 1130 in FIG. 11). Specifically, the area may be utilized as a cursor to select options for the kiosk interface.

FIG. 11 depicts a kiosk interface 1130 for providing airline options to a patron of an airline, according to embodiments described herein. As described above, at least a portion of the user interfaces 930 (FIG. 9) and 1030 (FIG. 10) may also be provided by the tone-based kiosk 104. However, some embodiments are configured such that the tone-based kiosk 104 may provide one or more interfaces that are either not provided by the mobile device 102 and/or are provided differently by the mobile device 102.

Regardless, the kiosk interface 1130 includes an edit reservation option 1132, a directions to gate option 1134, a directions to food option 1136, a directions to bathroom option 1138, a send request option 1140, and a send data option 1142. In response to selection of the edit reservation option 1132, another kiosk interface may be provided. In some embodiments, in response to selection of the edit reservation option 1132, a customer service represent may be contacted to assist.

In response to selection of the directions to gate option 1134, directions to the patron's gate may be provided. In response to selection of the directions to food option 1136, the patron may either view a map of various eateries and/or may enter a desired criteria for an eatery and receive directions to restaurants matching that criteria. In response to selection of the directions to bathroom option 1138, a map and/or directions to at least one restroom that are nearby, on the way to the patron's gate, on the way to an eatery, near an eatery, and/or near patron's gate may be provided. In response to selection of the send request option 1140, a request may be sent to airline personnel. Requests might include a request for wheelchair or other assistance navigating the airport, requests for refund, request for upgrade, etc. In response to selection of the send data option 1142, one or more pieces of data (e.g., directions, edited reservations, etc.) may be specifically communicated to the mobile device 102, such that when the patron leaves range of the tones emitted by the tone-based kiosk 104, the data is maintained.

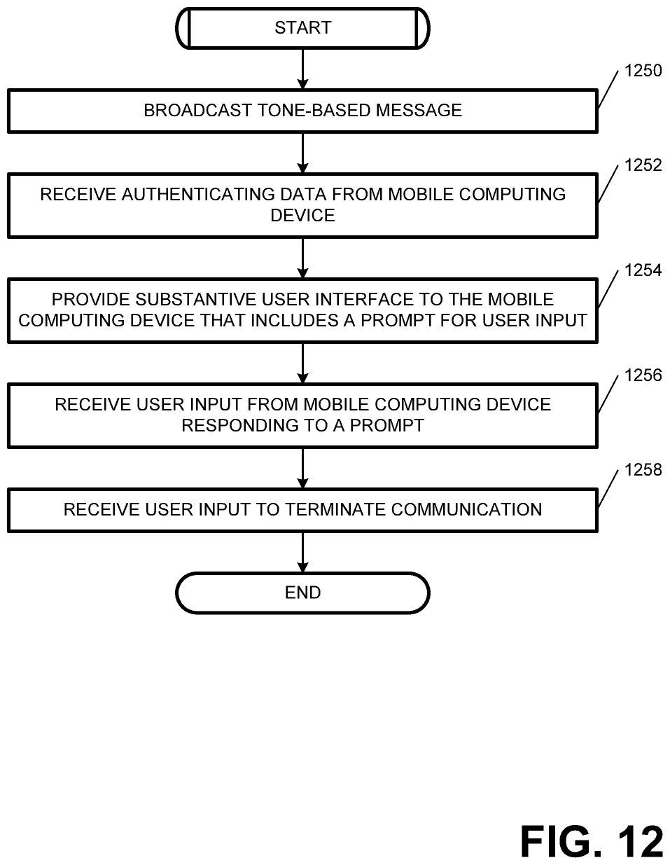

FIG. 12 depicts a flowchart for providing tone-based kiosk services by integrating with a user account, according to embodiments described herein. In block 1250, the tone-based kiosk 104 may broadcast a tone-based message. As a user with the mobile device 102 approaches the tone-based kiosk 104, the patron may login to his/her account with that establishment 200 and identify which tone-based kiosk 104 the patron will use. The establishment device 106 (which in this example is a web server or other similar component) may communicate the user information and/or other information to the tone-based kiosk 104 that the patron will use. The mobile device 102 may communicate similar authenticating data (such as via an encrypted message) utilizing a tone protocol directly to the tone-based kiosk 104. As such, in block 1252, the tone-based kiosk 104 may receive that authenticating data.

In block 1254, the tone-based kiosk 104 may provide a substantive interface that includes a prompt for user input to the mobile device 102 via a tone protocol. In block 1256, the tone-based kiosk 104 may receive user input responding to the prompt that was received from the user by the mobile device 102 and communicated by the mobile device 102 to the tone-based kiosk 104 via the tone protocol. Specifically, the tone-based kiosk 104 may communicate data for the mobile device 102 to display the same user interfaces being displayed by the tone-based kiosk 104. This allows a mirroring of the user interfaces provided by the tone-based kiosk 104. However, some embodiments may only provide user options and/or fields for the patron to use to interact with the user interfaces provided by the tone-based kiosk 104. In block 1258, once the transaction is complete, the user may select an option on the mobile device 102 to terminate the communication with the tone-based kiosk 104. The tone-based kiosk 104 may then delete any user data from local storage.

It should be understood that while some embodiments may utilize the establishment 200's mobile application and the patron's user account to facilitate this transaction; this is just one example. Some embodiments may be configured such that the patron accesses a predetermined website (of the establishment 200 or of a third party), where the patron provides an identifier for the tone-based kiosk 104 that the patron will utilize. The mobile device 102 and the tone-based kiosk 104 may then establish a secure link without necessarily having the patron log into any user account.

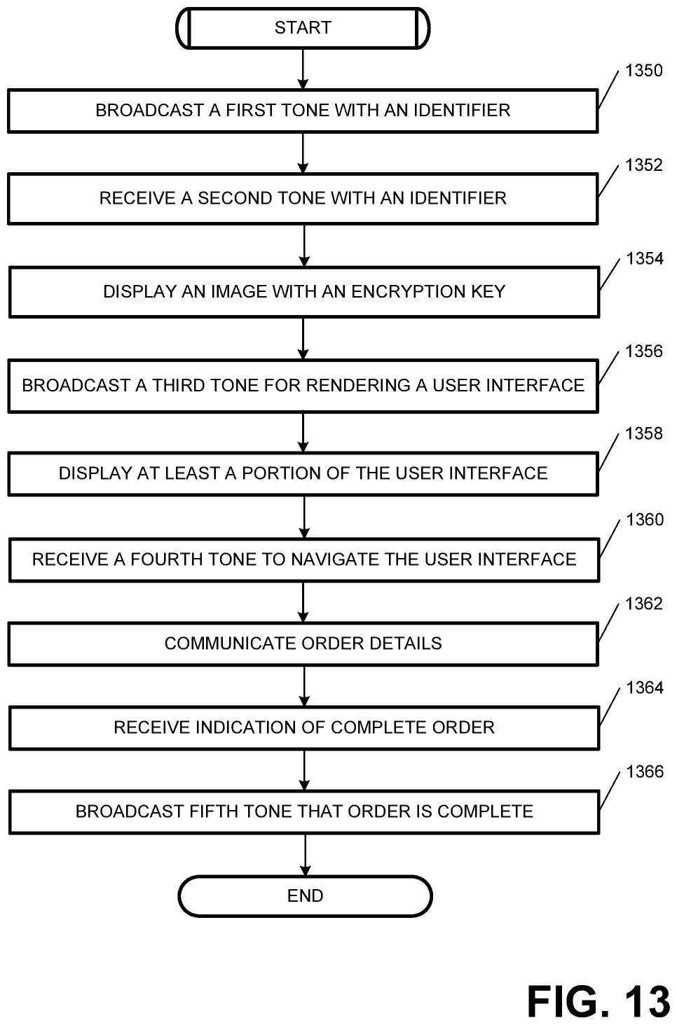

FIG. 13 depicts a flowchart for providing tone-based kiosk services, according to embodiments described herein. As illustrated in block 1350, a first tone that is imperceptible by a human may be broadcast by the tone-based kiosk 104. The first tone may include a first identifier of the tone-based kiosk 104 and the tone-based kiosk 104 may be configured to serve the establishment 200. In block 1352, a second tone may be received from the mobile device 102 of a patron, where the second tone includes a second identifier of the mobile device 102. In block 1354, an image that includes an encryption key for capture by the mobile device 102 may be displayed by the tone-based kiosk 104. The encryption key may be used by the mobile device 102 and the tone-based kiosk 104 to establish an encrypted connection. In block 1356, a third tone may be broadcast by the tone-based kiosk 104 that includes first encrypted data for rendering a user interface at the mobile device 102. The first encrypted data may include information related to offerings by the establishment 200. The first encrypted data may be received by the mobile device 102, decrypted, and displayed as the user interface.

In block 1358, at least a portion of the user interface may be displayed by the tone-based kiosk 104. In block 1360, a fourth tone may be broadcast by the tone-based kiosk 104 that includes second encrypted data that includes instructions navigating the user interface via the mobile device 102 to create order details for an order. In block 1362, at least a portion of the order details may be communicated to the establishment device 106 for processing the order. In block 1364, an indication may be received by the tone-based kiosk 104 that the order is complete. In block 1366, a fifth tone may be broadcast by the tone-based kiosk 104 that includes third encrypted data indicating that the order is complete.

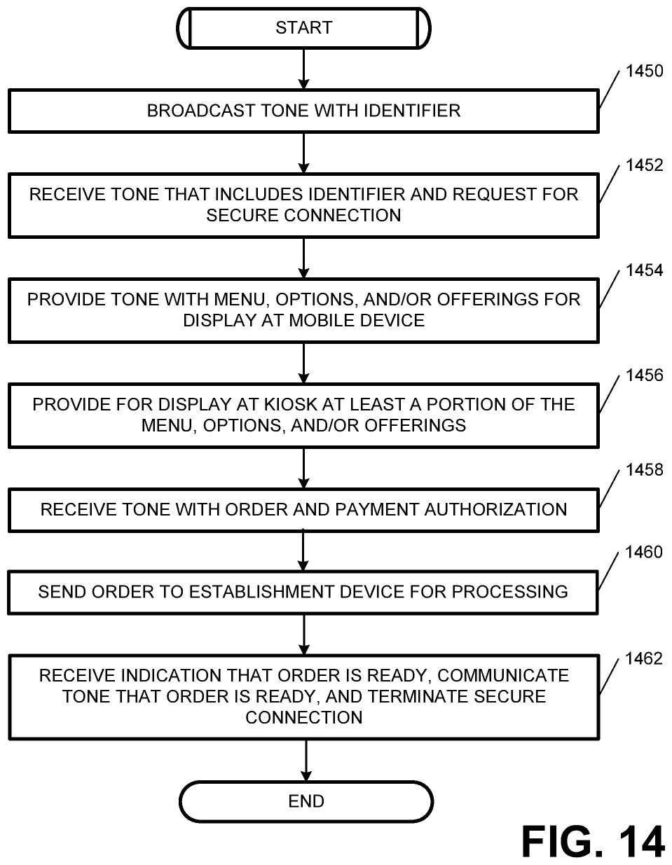

FIG. 14 depicts a flowchart for providing tone-based kiosk services to a restaurant patron, according to embodiments described herein. As illustrated in block 1450, a tone with an identifier may be broadcast by a tone-based kiosk 104. In block 1452, a tone may be received that includes an identifier and a request for a secure connection. In block 1454, a tone may be provided that includes data related to a menu, options, and/or other offerings may be provided for display on the mobile deice 102. In block 1456, at least a portion of the menu, options, and/or offerings are provided for display by the tone-based kiosk 104. In block 1458, a tone may be received with an order and/or payment authorization. In block 1460, data related to the order may be sent by the tone-based kiosk 104 to the establishment device 106. Depending on the embodiment, the data may be sent via another encrypted tone and/or via a traditional communication mechanism. In block 1462, an indication that the order is ready may be received; a tone may be broadcast that the order is ready; and the secure connection may be terminated.

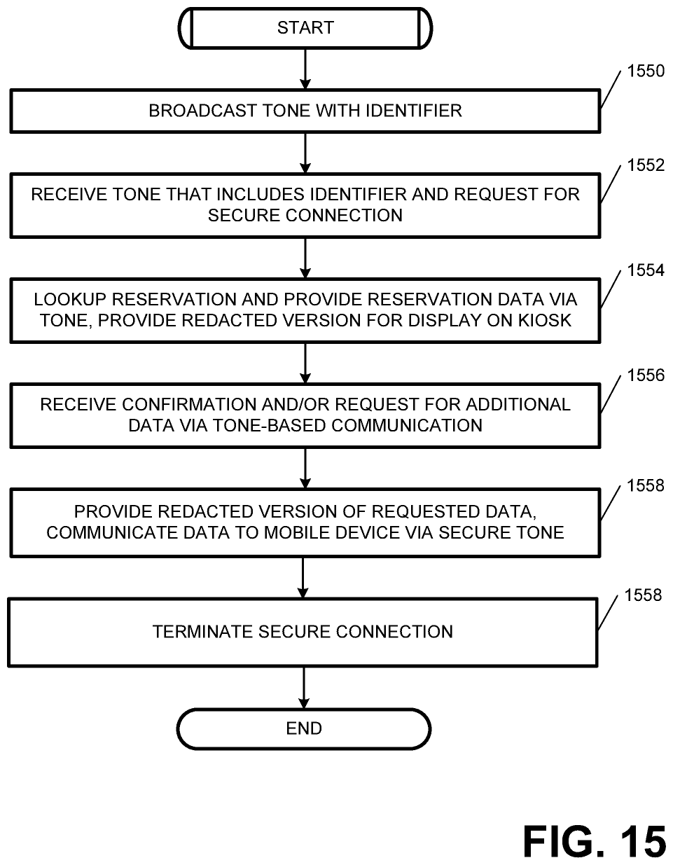

FIG. 15 depicts a flowchart for providing tone-based kiosk services to an airline patron, according to embodiments described herein. As illustrated in block 1550, a tone may be broadcast with an identifier. In block 1552, a tone may be received that includes an identifier of a mobile device 102 and a request for a secure connection. In block 1554, a reservation may be looked up and reservation data may be provided via a tone. A redacted version of the data may be provided for display on the tone-based kiosk 104. In block 1556, confirmation and/or a request for additional data may be received via tone based communication. In block 1558, a redacted version of the requested data may be provided for display and an altered version of the data may be provided to the mobile device 102 via an encrypted tone. In block 1558, the secure connection may be terminated.

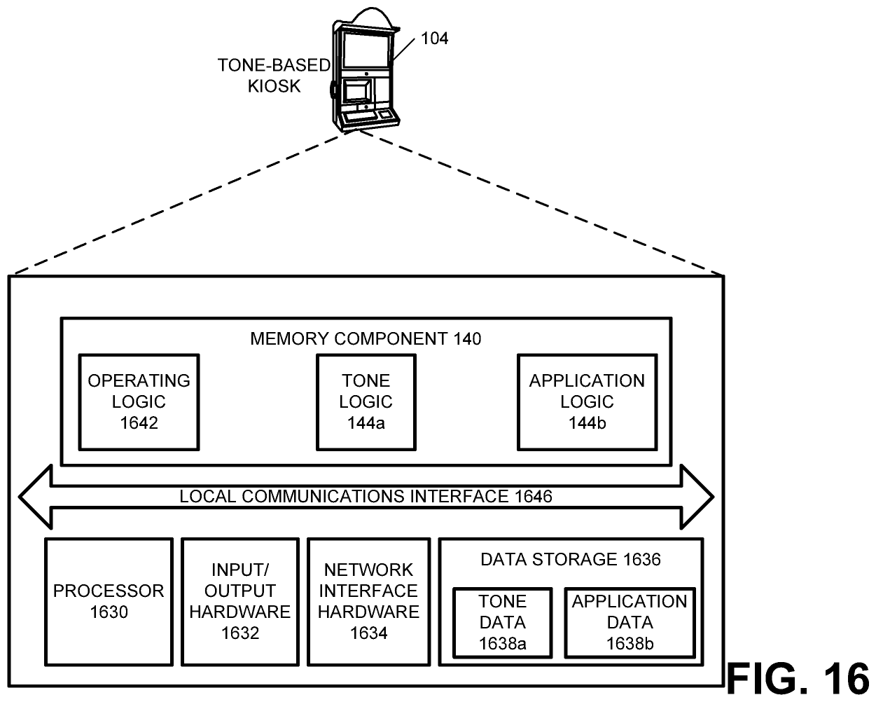

FIG. 16 depicts components of a tone-based kiosk 104, according to embodiments described herein. As illustrated, the tone-based kiosk 104 includes a processor 1630, input/output hardware 1632, a network interface hardware 1634, a data storage component 1636 (which stores tone data 1638a and/or application data 1638b), and a memory component 140. The memory component 140 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD) (whether local or cloud-based), and/or other types of non-transitory computer-readable medium. Depending on the particular embodiment, these non-transitory computer-readable mediums may reside within the tone-based kiosk 104 and/or external to the tone-based kiosk 104.

The memory component 140 may store operating logic 1642, the tone logic 144a, and the application logic 144b. Each of these logic components may include a plurality of different pieces of logic, each of which may be embodied as a computer program, firmware, and/or hardware, as an example. A local interface 1646 is also included in FIG. 16 and may be implemented as a bus or other communication interface to facilitate communication among the components of the tone-based kiosk 104.

The processor 1630 may include any processing component operable to receive and execute instructions (such as from a data storage component 1636 and/or the memory component 134). As described above, the input/output hardware 1632 may include and/or be configured to interface with speakers, microphones, and/or other input/output components.

The network interface hardware 1634 may include and/or be configured for communicating with any wired or wireless networking hardware, including an antenna, a modem, a LAN port, wireless fidelity (Wi-Fi) card, WiMAX card, mobile communications hardware, and/or other hardware for communicating with other networks and/or devices. From this connection, communication may be facilitated between the tone-based kiosk 104 and other computing devices.

The operating logic 1642 may include an operating system and/or other software for managing components of the tone-based kiosk 104. As discussed above, the tone logic 144a may reside in the memory component 140 and may be configured to cause the processor 1630 to receive commands from the mobile device 102 and/or the establishment device 106 to create, edit, and/or otherwise manage tone data and content. The application logic 144b may be configured to cause the processor 1630 to provide the application-based data and content to the tone-based kiosk 104, mobile device 102, and/or establishment device 106.

It should be understood that while the components in FIG. 16 are illustrated as residing within the tone-based kiosk 104, this is merely an example. In some embodiments, one or more of the components may reside external to the tone-based kiosk 104 or within other devices, such as those depicted in FIG. 1. It should also be understood that, while the tone-based kiosk 104 is illustrated as a single device, this is also merely an example. In some embodiments, the tone logic 144a and the application logic 144b may reside on different computing devices.

As an example, one or more of the functionalities and/or components described herein may be provided by the tone-based kiosk 104, the establishment device 106, and/or the mobile device 102. As an example, any of these devices may have similar components as those depicted in FIG. 16. To this end, any of these devices may include logic for performing the functionality described herein.

Additionally, while the tone-based kiosk 104 is illustrated with the tone logic 144a and the application logic 144b as separate logical components, this is also an example. In some embodiments, a single piece of logic may provide the described functionality. It should also be understood that while the tone logic 144a and the application logic 144b are described herein as the logical components, this is also an example. Other components may also be included, depending on the embodiment.

As illustrated above, various embodiments for providing a tone-based kiosk service are disclosed. These embodiments may not only improve the service provided to patrons, but also improve tracking and marketing for establishments. The use of non-naturally occurring tones to this end provides a touch-free mechanism for accurately locating patrons within the establishment, as well as allowing the communication of large amounts of data individually or to a group. Additionally, as the non-naturally occurring tones may be of a higher or lower than human perception frequency, line of sight between the mobile device 102 and the tone-based kiosk 104 may not be necessary.

Accordingly, various aspects of this disclosure are provide herein, including the following:

A first aspect includes a method for providing a tone-based kiosk service, comprising: broadcasting, by a tone-based kiosk, a first tone that is imperceptible by a human, wherein the first tone includes a first identifier of the tone-based kiosk, wherein the tone-based kiosk serves an establishment; receiving, by the tone-based kiosk, a second tone from a mobile device of a patron, wherein the second tone includes a second identifier of the mobile device; displaying, by the tone-based kiosk, an image that includes an encryption key for capture by the mobile device, wherein the encryption key is used by the mobile device and the tone-based kiosk to establish an encrypted connection; broadcasting, by the tone-based kiosk, a third tone that includes first encrypted data for rendering a user interface at the mobile device, wherein the first encrypted data includes information related to offerings by the establishment, wherein the first encrypted data is received by the mobile device, decrypted, and displayed as the user interface; displaying, by the tone-based kiosk, at least a portion of the user interface; receiving, by the tone-based kiosk, a fourth tone that includes second encrypted data that includes instructions navigating the user interface via the mobile device to create order details for an order; communicating, by the tone-based kiosk, at least a portion of the order details to an establishment device for processing the order; receiving, by the tone-based kiosk, an indication that the order is complete; and broadcasting, by the tone-based kiosk, a fifth tone that includes third encrypted data indicating that the order is complete.

A second aspect includes the first aspect, further comprising redacting at least a portion of the user interface for display by the tone-based kiosk.

A third aspect includes the first aspect and/or second aspect, further comprising predicting a time to complete the order.

A fourth aspect includes any of the first aspect through the third aspect, further comprising: predicting a time to complete orders for a plurality of establishment offerings; ranking the plurality of establishment offerings according to the time; and providing the ranking for display.

A fifth aspect includes any of the first aspect through the fourth aspect, wherein the establishment includes at least one of the following: a restaurant, an airline, or a retail establishment.

A sixth aspect includes any of the first aspect through the fifth aspect, wherein the establishment includes an airline, and wherein the method further includes displaying at the tone-based kiosk a first option for at least one of the following: providing directions to a gate, providing directions to an eatery, providing directions to a restroom, changing a reservation, or requesting assistance.

A seventh aspect includes any of the first aspect through the sixth aspect, further comprising providing a second option to communicate data related to the first option to the mobile device for use after the mobile device is out of range of the tone-based kiosk.

An eighth aspect includes a system for providing a tone-based kiosk service, comprising: a tone-based kiosk with a display coupled to a processor and a memory component, wherein the memory component stores logic that, when executed by the processor, causes the tone-based kiosk to perform at least the following: broadcast a first tone that is imperceptible by a human, wherein the first tone includes a first identifier of the tone-based kiosk, wherein the tone-based kiosk serves an establishment; receive a second tone from a mobile device of a patron, wherein the second tone includes a second identifier of the mobile device; establish an encrypted connection with the mobile device; broadcast a third tone that includes first encrypted data for rendering a user interface at the mobile device, wherein the first encrypted data includes information related to offerings by the establishment, wherein the first encrypted data is received by the mobile device, decrypted, and displayed as the user interface; provide at least a portion of the user interface for display; receive a fourth tone that includes second encrypted data that includes instructions navigating the user interface via the mobile device to create order details for an order; receive an indication that the order is complete; and broadcast a fifth tone that includes third encrypted data indicating that the order is complete.

A ninth aspect includes the eighth aspect, further comprising an establishment device for receiving at least a portion of the order details related to the order for processing and sending an indication of the tone-based kiosk when the order is complete.

A tenth aspect includes the eighth aspect and/or ninth aspect, further comprising the mobile device.

An eleventh aspect includes any of the eighth aspect through the tenth aspect, wherein the logic further causes the system to redact at least a portion of the user interface for display by the tone-based kiosk.

A twelfth aspect includes any of the eighth aspect through the eleventh aspect, wherein the logic further causes the system to predict a time to complete the order.

A thirteenth aspect includes any of the eighth aspect through the twelfth aspect, wherein the logic further causes the system to perform at least the following: predict a time to complete orders for a plurality of establishment offerings; rank the plurality of establishment offerings according to the time; and provide the ranking for display.

A fourteenth aspect includes any of the eighth aspect through the thirteenth aspect, wherein the establishment includes an airline, and wherein the logic further causes the system to perform at least the following: display at the tone-based kiosk a first option for at least one of the following: providing directions to a gate, providing directions to an eatery, providing directions to a restroom, changing a reservation, or requesting assistance; and provide a second option to communicate data related to the first option to the mobile device for use after the mobile device is out of range of the tone-based kiosk.

A fifteenth aspect includes a tone-based kiosk for providing a tone-based service, comprising: a display; a processor coupled to the display; and a memory component coupled to the processor, wherein the memory component stores logic that, when executed by the processor, causes the tone-based kiosk to perform at least the following: establish an encrypted connection with a mobile device; broadcast a first tone that includes first encrypted data for rendering a user interface at the mobile device, wherein the first encrypted data includes information related to offerings by an establishment, wherein the first encrypted data is received by the mobile device, decrypted, and displayed as the user interface; provide at least a portion of the user interface for display; receive a second tone that includes second encrypted data that includes instructions navigating the user interface via the mobile device to create order details for an order; receive an indication that the order is complete; and broadcast a third tone that includes third encrypted data indicating that the order is complete.

A sixteenth aspect includes the fifteenth aspect, wherein the logic further causes the tone-based kiosk to redact at least a portion of the user interface for display by the tone-based kiosk.

A seventeenth aspect includes the fifteenth aspect and/or the sixteenth aspect wherein the logic further causes the tone-based kiosk to predict a time to complete the order.

An eighteenth aspect includes any of the fifteenth aspect through the seventeenth aspect, wherein the logic further causes the tone-based kiosk to perform at least the following: predict a time to complete orders for a plurality of establishment offerings; rank the plurality of establishment offerings according to the time; and provide the ranking for display.

A nineteenth aspect includes any of the fifteenth aspect through the eighteenth aspect, wherein the establishment includes at least one of the following: a restaurant, an airline, or a retail establishment.

A twentieth aspect includes any of the fifteenth aspect through the nineteenth aspect, wherein the establishment includes an airline, and wherein the logic further causes the tone-based kiosk to perform at least the following: display at the tone-based kiosk a first option for at least one of the following: providing directions to a gate, providing directions to an eatery, providing directions to a restroom, changing a reservation, or requesting assistance; and provide a second option to communicate data related to the first option to the mobile device for use after the mobile device is out of range of the tone-based kiosk.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

It should now be understood that embodiments disclosed herein include systems, methods, and non-transitory computer-readable mediums for providing a tone-based service. It should also be understood that these embodiments are merely exemplary and are not intended to limit the scope of this disclosure.

What is claimed is:

1. A method for providing a tone-based kiosk service, comprising:
broadcasting, by a tone-based kiosk, a first tone that is imperceptible by a human, wherein the first tone includes a first identifier of the tone-based kiosk, wherein the tone-based kiosk serves an establishment;
receiving, by the tone-based kiosk, a second tone from a mobile device of a patron, wherein the second tone includes a second identifier of the mobile device;
displaying, by the tone-based kiosk, an image that includes an encryption key for capture by the mobile device, wherein the encryption key is used by the mobile device and the tone-based kiosk to establish an encrypted connection;
broadcasting, by the tone-based kiosk, a third tone that includes first encrypted data for rendering a user interface at the mobile device, wherein the first encrypted data includes information related to offerings by the establishment, wherein the first encrypted data is received by the mobile device, decrypted, and displayed as the user interface;
displaying, by the tone-based kiosk, at least a portion of the user interface;
receiving, by the tone-based kiosk, a fourth tone that includes second encrypted data that includes instructions navigating the user interface via the mobile device to create order details for an order;
communicating, by the tone-based kiosk, at least a portion of the order details to an establishment device for processing the order;
receiving, by the tone-based kiosk, an indication that the order is complete; and
broadcasting, by the tone-based kiosk, a fifth tone that includes third encrypted data indicating that the order is complete.

2. The method of claim 1, further comprising redacting at least a portion of the user interface for display by the tone-based kiosk.

3. The method of claim 1, further comprising predicting a time to complete the order.

4. The method of claim 1, further comprising:
predicting a time to complete orders for a plurality of establishment offerings;
ranking the plurality of establishment offerings according to the time; and
providing the ranking for display.

5. The method of claim 1, wherein the establishment includes at least one of the following: a restaurant, an airline, or a retail establishment.

6. The method of claim 1, wherein the establishment includes an airline, and wherein the method further includes displaying at the tone-based kiosk a first option for at least one of the following: providing directions to a gate, providing directions to an eatery, providing directions to a restroom, changing a reservation, or requesting assistance.

7. The method of claim 6, further comprising providing a second option to communicate data related to the first option to the mobile device for use after the mobile device is out of range of the tone-based kiosk.

8. A system for providing a tone-based kiosk service, comprising:
a tone-based kiosk with a display coupled to a processor and a memory component, wherein the memory component stores logic that, when executed by the processor, causes the tone-based kiosk to perform at least the following:
broadcast a first tone that is imperceptible by a human, wherein the first tone includes a first identifier of the tone-based kiosk, wherein the tone-based kiosk serves an establishment;
receive a second tone from a mobile device of a patron, wherein the second tone includes a second identifier of the mobile device;
establish an encrypted connection with the mobile device;
broadcast a third tone that includes first encrypted data for rendering a user interface at the mobile device, wherein the first encrypted data includes information related to offerings by the establishment, wherein the first encrypted data is received by the mobile device, decrypted, and displayed as the user interface;
provide at least a portion of the user interface for display;
receive a fourth tone that includes second encrypted data that includes instructions navigating the user interface via the mobile device to create order details for an order;
receive an indication that the order is complete; and
broadcast a fifth tone that includes third encrypted data indicating that the order is complete.

9. The system of claim 8, further comprising an establishment device for receiving at least a portion of the order details related to the order for processing and sending an indication of the tone-based kiosk when the order is complete.

10. The system of claim 8, further comprising the mobile device.

11. The system of claim 8, wherein the logic further causes the system to redact at least a portion of the user interface for display by the tone-based kiosk.

12. The system of claim 8, wherein the logic further causes the system to predict a time to complete the order.

13. The system of claim 8, wherein the logic further causes the system to perform at least the following:
predict a time to complete orders for a plurality of establishment offerings;
rank the plurality of establishment offerings according to the time; and
provide the ranking for display.

14. The system of claim 8, wherein the establishment includes an airline, and wherein the logic further causes the system to perform at least the following:
display at the tone-based kiosk a first option for at least one of the following: providing directions to a gate, providing directions to an eatery, providing directions to a restroom, changing a reservation, or requesting assistance; and
provide a second option to communicate data related to the first option to the mobile device for use after the mobile device is out of range of the tone-based kiosk.

15. A tone-based kiosk for providing a tone-based service, comprising:
a display;
a processor coupled to the display; and
a memory component coupled to the processor, wherein the memory component stores logic that, when executed by the processor, causes the tone-based kiosk to perform at least the following:
establish an encrypted connection with a mobile device;
broadcast a first tone that includes first encrypted data for rendering a user interface at the mobile device, wherein the first encrypted data includes information related to offerings by an establishment, wherein the first encrypted data is received by the mobile device, decrypted, and displayed as the user interface;
provide at least a portion of the user interface for display;
receive a second tone that includes second encrypted data that includes instructions navigating the user interface via the mobile device to create order details for an order;
receive an indication that the order is complete; and
broadcast a third tone that includes third encrypted data indicating that the order is complete.

16. The tone-based kiosk of claim 15, wherein the logic further causes the tone-based kiosk to redact at least a portion of the user interface for display by the tone-based kiosk.

17. The tone-based kiosk of claim 15, wherein the logic further causes the tone-based kiosk to predict a time to complete the order.

18. The tone-based kiosk of claim 15, wherein the logic further causes the tone-based kiosk to perform at least the following:
predict a time to complete orders for a plurality of establishment offerings;
rank the plurality of establishment offerings according to the time; and
provide the ranking for display.

19. The tone-based kiosk of claim 15, wherein the establishment includes at least one of the following: a restaurant, an airline, or a retail establishment.

20. The tone-based kiosk of claim 15, wherein the establishment includes an airline, and wherein the logic further causes the tone-based kiosk to perform at least the following:
display at the tone-based kiosk a first option for at least one of the following: providing directions to a gate, providing directions to an eatery, providing directions to a restroom, changing a reservation, or requesting assistance; and
provide a second option to communicate data related to the first option to the mobile device for use after the mobile device is out of range of the tone-based kiosk.
